(19) United States
(12) Patent Application Publication
(10) Pub. No.: US 2022/0391244 A1
(43) Pub. Date: Dec. 8, 2022

(54) DECENTRALIZED CLUSTER FEDERATION IN COMPUTER NETWORK NODE MANAGEMENT SYSTEMS

(71) Applicant: TELEFONAKTIEBOLAGET LM ERICSSON (PUBL), Stockholm (SE)

(72) Inventors: Harald Gustafsson, LUND (SE); Lars Larsson, Lund (SE)

(21) Appl. No.: 17/774,593

(22) PCT Filed: Nov. 7, 2019
(86) PCT No.: PCT/EP2019/080561

§ 371 Date: May 5, 2022

(51) Int. Cl. G06F 9/48; H04L 47/70; G06F 16/23

(52) U.S. Cl. CPC G06F 9/4881; H04L 47/82; G06F 16/23

(57) ABSTRACT

An arrangement includes a plurality of clusters and an interface through which a distributed federation database is accessible, wherein each of the clusters includes a cluster interface; a cluster local memory configured to store local cluster resources; and a federation controller. The federation controller is configured to: receive a first notification from the distributed federation database, wherein the first notification indicates a change relating to a federation resource in the distributed federation database; analyze the first notification; modify the local resource based on the analysis; and update a status of the federation resource in the distributed federation database when the local resource has been stored.

### BACKGROUND

The present invention relates to management of computer network node resources, and more particularly to management of resources associated with plural clusters of nodes in a computer network.

Kubernetes is a technology for managing resources on a set of computer nodes. Commonly this is to manage containers or pods, but also other resources as persistent storage, configurations, secrets, or custom objects. Kubernetes has a logical master for each cluster (although the logical master may, in some embodiments, be distributed among nodes within a single cluster for availability reasons). The logical master handles an Application Program Interface (API) entry point that provides cluster access to one or more clients, a resource database, and performs other duties as controller of worker nodes to manage resources according to specification. Such master and worker nodes are called a cluster. Due to availability and performance constraints, a cluster should not be geographically distributed; instead, multi-cluster solutions are preferred. A current multi-cluster solution is Kubernetes federation version 2, which has one cluster that acts as a central controller of resources to all the clusters in the federation. This is done by having federation resource types that specify a resource template, placement and override rules of template information. A federation controller in the host cluster watches such federation resources and continuously writes them to the placement clusters.

As an alternative to the Kubernetes solution, another approach allows, for federation resources, such as resource specifications, to be committed to git repositories, with a cluster local controller continuously pulling information from the git repository and applying the changes into the Kubernetes resource database.

These existing cluster federation technologies have associated problems. For example, the Kubernetes federation approach can handle only a limited number of clusters due to scalability issues in the controller. Moreover, its design provides a central single point of failure for managing all clusters, which provides problems, e.g., during network partitioning.

The other alternative, with git repositories, has longer latencies due to reliance on the pull model. It also has difficulties with dynamic changes, for example, scheduling pods over several clusters.

Hence there is a need for technology that addresses the above and/or related issues.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

Moreover, reference letters may be provided in some instances (e.g., in the claims and summary) to facilitate identification of various steps and/or elements. However, the use of reference letters is not intended to impute or suggest that the so-referenced steps and/or elements are to be performed or operated in any particular order.

In accordance with one aspect of the present invention, the foregoing and other objects are achieved in technology (e.g., methods, apparatuses, nontransitory computer readable storage media, program means) federates a plurality of clusters. The technology involves the plurality of clusters and an interface through which a distributed federation database is accessible. Each of the clusters comprises a cluster interface; a cluster local memory configured to store local cluster resources; and a federation controller. In one aspect of embodiments consistent with the invention, each cluster, in some embodiments under the direction of the federation controller, receives a first notification from the distributed federation database, wherein the first notification indicates a change relating to a federation resource in the distributed federation database. The cluster analyzes the first notification; modifies a local resource based on the analysis; and updates a status of the federation resource in the distributed federation database when the local resource has been stored.

In an aspect of some but not necessarily all embodiments, receiving the first notification from the distributed federation database comprises initiating receipt of notifications from the distributed federation database by sending a watch federation resources message to the distributed federation database.

In an aspect of some but not necessarily all embodiments, the cluster detects when the first notification from the distributed federation database indicates that the federation resource has been created, and in response thereto, derives a cluster local resource when the analysis indicates that the cluster local resource should be derived; stores the derived cluster local resource in the cluster local memory; and updates the status of the federation resource in the distributed federation database when the derived cluster local resource has been stored.

In an aspect of some but not necessarily all embodiments, the cluster detects when the first notification from the distributed federation database indicates that the federation resource has been updated, and in response thereto, derives an updated cluster local resource when the analysis indicates that a previously stored cluster local resource should be updated; stores the derived updated cluster local resource in the cluster local memory; and updates the status of the federation resource in the distributed federation database when the derived updated cluster local resource has been stored.

In an aspect of some but not necessarily all embodiments, the cluster detects when the first notification from the distributed federation database indicates that the federation resource has been marked for deletion, and in response thereto, determines that a corresponding derived cluster local resource should be deleted; deletes the corresponding derived cluster local resource from the cluster local memory; updates the status of the federation resource in the distributed federation database when the corresponding derived cluster local resource has been deleted from the cluster local memory; and receives a second notification from the distributed federation database indicating that no derived cluster local resources corresponding to the federation resource are stored in any of the plurality of clusters, and in response to the second notification to delete the federation resource from the distributed federation database.

In an aspect of some but not necessarily all embodiments, one of the plurality of clusters detects when the first notification indicates a scheduling federation resource including a request for creation of an aggregate number of instances of a resource among the plurality of clusters, and responds to the specification by deriving a suitability parameter that represents how suitable the first one of the plurality of clusters is for handling the request; deriving a number of resources to be handled by the first cluster, wherein the number is based at least in part on the suitability parameter; and updating the status of the federation resource in the distributed federation database to indicate the suitability parameter and the number of resources to be handled by the first cluster.

In an aspect of some but not necessarily all embodiments, the first cluster receives one or more further notifications, each indicating an updated status of the scheduling federation resource, and in response thereto to retrieves a suitability parameter of at least one other one of the plurality of clusters and a committed number of resources to be handled by said at least one other one of the plurality of clusters; derive an adjusted number of resources to be handled by the first cluster based at least in part on the suitability parameter of the first cluster and the suitability parameters of said at least one other one of the plurality of clusters, and the committed number of resources to be handled by said at least one other one of the plurality of clusters; and updates the status of the federation resource in the distributed federation database to indicate the suitability parameter of the first cluster and the adjusted number of resources to be handled by the first cluster.

In an aspect of some but not necessarily all embodiments, the cluster creates a number of derived local cluster resources in correspondence with the number of resources to be handled by the first cluster or in correspondence with the adjusted number of resources to be handled by the first cluster; stores the derived local cluster resources in the cluster local memory; and updates the status of the federation resource in the distributed federation database when the derived local cluster resources have been stored in the cluster local memory.

In an aspect of some but not necessarily all embodiments, the scheduling resource includes a policy (605) that governs creation of the resources to be created among the plurality of clusters; and the cluster derives the suitability parameter based at least in part on the policy.

In an aspect of some but not necessarily all embodiments, the cluster derives the suitability parameter based on cluster-specific information.

In an aspect of some but not necessarily all embodiments, deriving the number of resources to be handled by the first cluster comprises selecting a higher number of resources to be handled by the first cluster the higher the suitability parameter is.

### BRIEF DESCRIPTION OF THE DRAWINGS

The objects and advantages of the invention will be understood by reading the following detailed description in conjunction with the drawings in which:

FIG. 1 is a block diagram of an exemplary federation 100 of clusters

FIG. 2 is a high level flowchart of aspects relating to operation of federated clusters in accordance with some but not necessarily all exemplary embodiments consistent with the invention.

FIG. 3 shows some of the actions and signal flows relating to initialization of the various components in a cluster in accordance with some but not necessarily all exemplary embodiments consistent with the invention.

FIG. 4 shows some of the actions and signal flows relating to creation or updating of a federation resource in the distributed Federation database in accordance with some but not necessarily all exemplary embodiments consistent with the invention.

FIG. 5 shows some of the actions and signal flows relating to deletion of a federation resource in the distributed federation database in accordance with some but not necessarily all exemplary embodiments consistent with the invention.

FIGS. 6A and 6B are flowcharts of actions performed by each federation controller with respect to distributed scheduling of resources among a federation of clusters, in accordance with some but not necessarily all exemplary embodiments consistent with the invention.

FIG. 7 illustrates an exemplary federation controller of a cluster in a federation of clusters in accordance with some but not necessarily all exemplary embodiments consistent with the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits alone, one or more programmed processors, or any combination of these). Moreover, the invention can additionally be considered to be embodied entirely within any form of nontransitory computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

In order to facilitate a better understanding of the description, much of the terminology used herein comes from Kubernetes technology, which is well-understood by those of ordinary skill in the art. However, this choice of terminology is not to be construed as an imposition of limitations on the scope of the inventive embodiments. To the contrary, those of ordinary skill in the art will understand how to apply the various technological aspects described herein in other, non-Kubernetes type arrangements.

In some embodiments, it is advantageous to reuse the Kubernetes federation version 2 resource types to allow identical specification for clients. But in addition to the conventional aspects, the herein-described technology introduces a different dynamic distributed data model and controllers. Unlike in conventional architectures, federated resource types are not stored in a Kubernetes local database (henceforth also referred to herein as “etcd” as is known in the art because it is the default implementation of the Kubernetes local database functionality) but are instead stored in a common distributed database that is equally accessible to each of the clusters in the federation. In accordance with this model, federated resource specifications are stored in this common database while cluster local resources continue to use the (local) etcd database. With this arrangement, there is no need for a federated sync controller because data is directly available to each cluster in the common distributed database. The distributed database will have local replicas at the clusters that needs it and hence have high availability and scale well to many clusters. This also allows clients to connect to any of the clusters to apply federated resources.

Another difference between the herein-described technology and that of the conventional model is that the various clusters' respective instantiations of federated resource templates do not need to be controlled from a central federation host. Instead, each cluster has its own local federation controller that applies resources directly to its corresponding etcd database based on the federation resource specification stored in the commonly-accessible distributed common database. This improves availability and scalability.

In another aspect, dynamically determined allocation of a number of resources over a set of clusters is now decided in a distributed fashion by the local federation controllers of the clusters, rather than by a single, central controller. As an example, conventional technology utilizes a central pod scheduling controller to monitor pod deployments in all the clusters and, based on the monitoring, to decide when to change the number of pods to deploy in each cluster. By contrast, the each one of the distributed set of controllers in the herein-described technology individually decides how many pods to deploy in its cluster and updates its part of the state in the distributed common database. As this state information is available to all of the clusters, each controller can then find out if the aggregate sum of pods over the totality of federated clusters is correct and what action(s) might be needed to fulfill the resource specification.

These and other aspects of the technology are described in further detail in the following description.

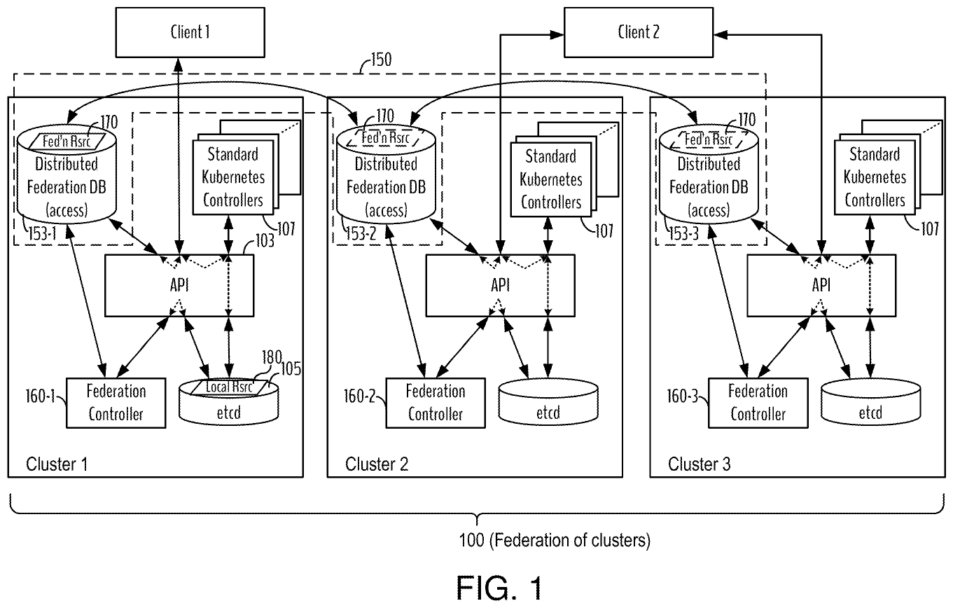

FIG. 1 is a block diagram of an exemplary federation 100 of clusters, here individually denoted “cluster 1”, “cluster 2”, and “cluster 3”. The number of clusters shown is merely for purposes of illustration, and in other embodiments there could be more or fewer clusters than those shown. Each one of the exemplary clusters includes some technology that is also found in conventional architectures, such as an Application Program Interface (API) 103, a local database (herein exemplified by the illustrated Kubernetes-compliant etcd 105) and a conventional controller, herein exemplified by the illustrated Kubernetes-compliant standard Kubernetes controllers 107. It is noted that Kubernetes provides for a number of different controllers that are responsible for respectively different areas, and that these are referred to collectively herein.

The API 103 enables communication between outside clients (e.g., the illustrated client 1, and client 2) and at least some components within the cluster. The API 103 can also allow some components within a cluster to communicate with each other. These various interconnections are schematically illustrated by the dotted lines within each API 103. Although not required in all embodiments, having communication between entities take place via the API 103 is advantageous because it provides a proper access control mechanism with permissions and the like.

Federation of clusters is brought about by further inclusion of a distributed federation database 150 that is common among all of the federated clusters (cluster 1, cluster 2, and cluster 3) and by further inclusion of a federation controller 160-1, 160-2, 160-3 within each respective one of the federated clusters. Each of the federation controllers 160-1, 160-2, 160-3 operates in the same way, so any one of them can therefore also be generically referred to as federation controller 160.

The distributed federation database 150 is a single database that is commonly accessible to each one of the clusters. In FIG. 1, it is indicated as being at least partly located in each one of the clusters 1, 2, and 3. However, in alternative embodiments the distributed federation database 150 can be embodied outside of the clusters 1, 2, 3, in which case it could be viewed as a single database that stretches across all of the federated clusters.

Implementations of distributed databases are known in the art, and therefore need not be described herein in detail. In embodiments consistent with the invention, the distributed federation database 150 is addressable in the network, and this is independent of whether it is physically implemented within or outside of a cluster. In some but not necessarily all embodiments, the distributed federation database 150 is accessible at one or more endpoints, potentially as proxies (especially when the distributed federation database 150 is itself implemented outside a cluster). For example, the distributed federation database 150 can have one endpoint in each cluster, which is then network routed to the distributed federation database 150. In these particular embodiments, such an endpoint/proxy then serves as an interface 153 that provides access to the distributed federation database 150.

For this reason, the exemplary embodiments illustrated by FIG. 1 do not show the federation controller 160 communicating with distributed federation database 150 through the API 103, although such alternative embodiments are also envisioned. In any case, however, clients still have a path to the distributed federation database 150 (or in some embodiments to an endpoint/proxy interface 153-n) via the API 103, and this type of access is shown in the Figures. The client communicates with the API 103, which then communicates with the endpoint/proxy interface 153 to the distributed federation database 150.

Also, for purposes of illustration, a federation resource 170 is shown being stored in the distributed federation database 150. It is shown with solid lines in one of the clusters, and with dashed lines in others to schematically illustrate that the same federation resource 170 is accessible in all of the federation clusters. Also for purposes of illustration, a local resource 180, corresponding to the federation resource 170, is shown being stored in the local database 105 of cluster 1. There may or may not be other local instantiations of the federation resource 170 in one or more other clusters.

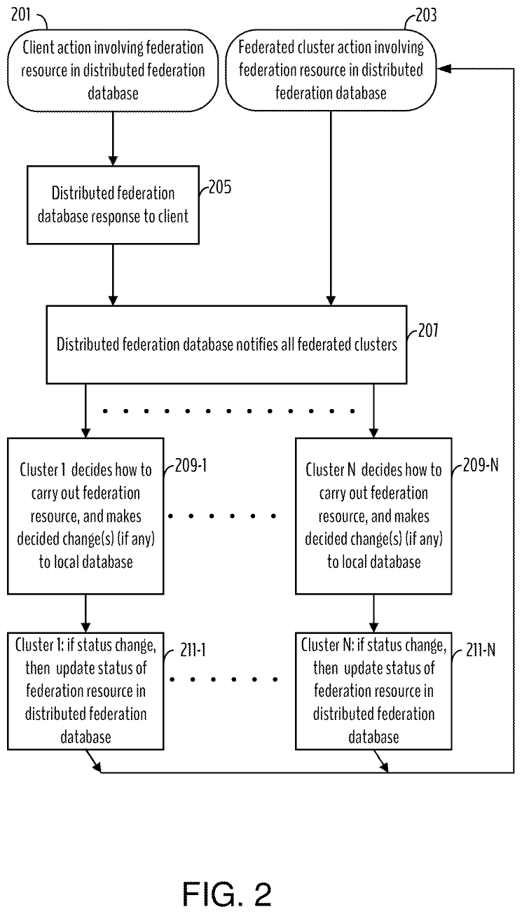

FIG. 2 is a high level flowchart of aspects relating to operation of federated clusters. In theory, any number of clusters can be in the federation, and in this example the total number is denoted “N”. Actions pertaining to the federation of clusters can be triggered in a number of different ways. One of these involves a client taking some action involving a federation resource with respect to the distributed federation database 150 (e.g., create resource, change resource, delete resource) (step 201). In these cases, the distributed federation database 150 returns a response to the client (e.g., so the client will know that the requested action has been accepted). Depending on the embodiment, communications between various entities (including, but not limited to, responses) can be made directly or indirectly (e.g., via the API 103 illustrated in the embodiment of FIG. 1). It is noted that the client's action will, among other things, result in a status change in relation to a federation resource.

In other cases, federation actions can be triggered by one or more of the clusters changing a status of a resource that is stored in the distributed federation database 150 (step 203).

In either case (i.e. client- or cluster-instigated triggering), the distributed federation database notifies all of the clusters in the federation 100 about the changed state of the distributed federation database 150.

In response to being notified, each of the clusters in the federation 100 makes its own decision about how (if at all) to locally carry out the new or changed federation resource, and then take steps to make the decided change(s) (if any) to the cluster's own local database 105 (step 209-x) (where “x” generally denotes any one of the N clusters).

If the cluster's action results in a local status change relating to the federated resource, then that cluster x updates the status of the corresponding federation resource in the distributed federation database 150.

As mentioned earlier, a change in status of a federation resource triggers further notifications to the federated clusters, so processing reverts back to step 203.

The above and additional aspects of the new technology will now be described in further detail.

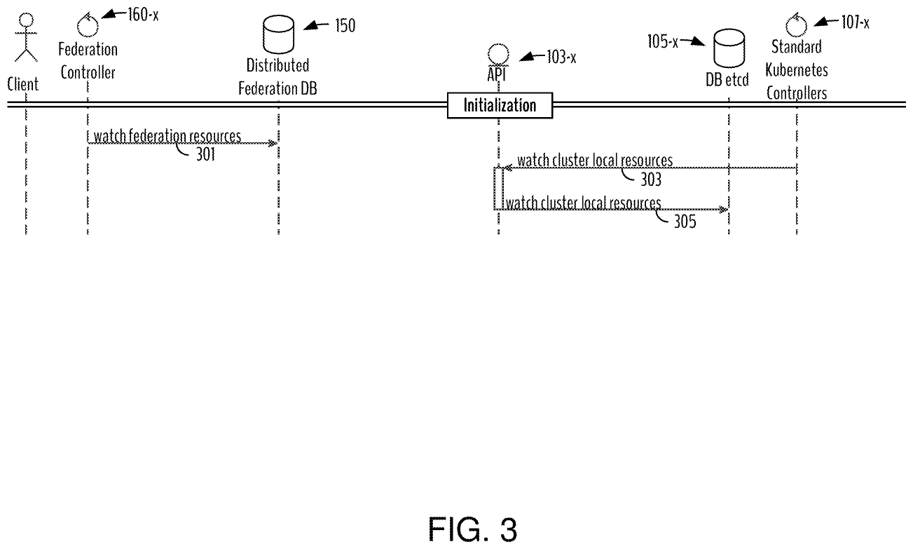

Referring now to FIG. 3, this shows some of the actions and signal flows relating to initialization of the various components discussed above. To avoid cluttering the figure, only one federation controller 160-x is depicted. As mentioned before, each of the federation controllers 160-x operates in the same way, so this figure is illustrative of actions and messages in connection with each of the clusters in the federation.

It was shown in step 207 that the distributed federation database 150 sends notifications to the N clusters of the federation 100 when a federation resource undergoes a status change. In some but not necessarily all embodiments, this is brought about by the federation controller 160-x sending a “watch federation resources” message to the distributed federation database 150. This arms the distributed federation database 150 to send a notification to the federation controller 160-x whenever there is a status change to a resource of the distributed federation database 150.

The standard Kubernetes controllers 107-x similarly send a “watch cluster local resources” message to its local database (etcd 105-x). However, this message flows through the cluster's API 103-x, so it is in two parts: an original message 303 sent from the standard Kubernetes controllers 107-x to the API 103-x, and its relayed version 305 sent from the API 103-x to the local database 105-x. This arms the local database 105-x to send a notification to the standard Kubernetes controllers 107-x whenever there is a status change to a resource of the local database 105-x.

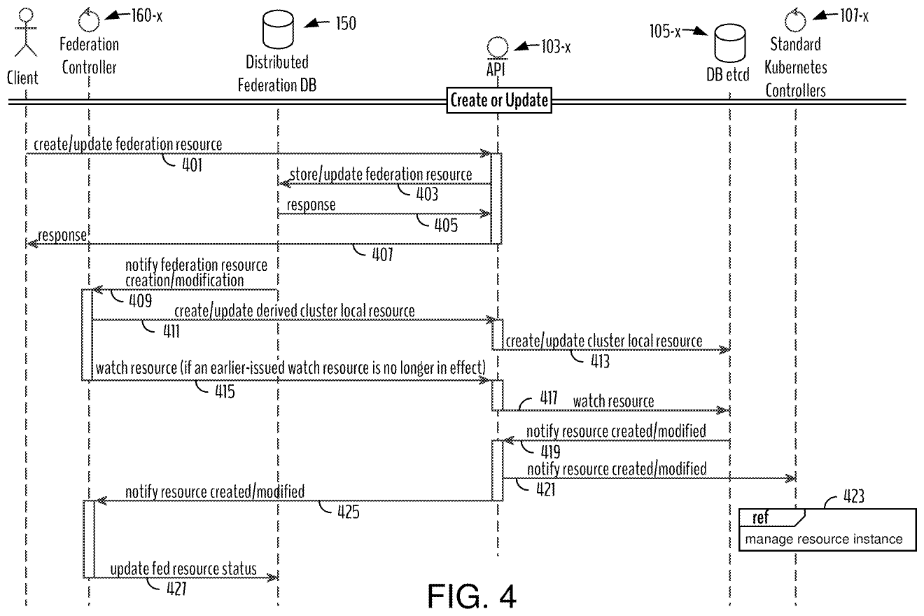

Further aspects of the technology are now described with reference to FIG. 4, which shows some of the actions and signal flows relating to creation or updating of a federation resource in the distributed federation database 150. To avoid cluttering the figure, only one federation controller 160-x is depicted. As mentioned before, each of the federation controllers 160-x operates in the same way, so this figure is illustrative of actions and messages in connection with each of the clusters.

Creating a federation resource and updating a federation resource follow the same type of processing, which begins with a client sending a message (“create/update federation resource”) (step 401) to an API 103-x of any one of the clusters within the federation 100. It will be noted that it does not matter which of the clusters receives the message because once the distributed federation database 150 is modified, all of the clusters in the federation 100 will be notified about the modification, and thereby be able to respond if appropriate.

The API 103-x forwards the client's message to the distributed federation database 150 (step 403). In return, the distributed federation database 150 sends a response (step 405) to the API 103-x, which forwards the response back to the client (step 407).

The distributed federation database 150 also sends a notification concerning the database creation/modification to each federation controller 160-x that is “watching” the distributed federation database 150 (step 409), and in practice this should be every cluster in the federation 100.

Assuming that the create/update federation resource instruction is applicable to the cluster (depending on the particular contents of the notification, the federation controller 160-x may need to perform an analysis to decide the notification's applicability to the cluster), the cluster's federation controller 160-x causes the cluster's local database 105-x to be modified. This is achieved by the federation controller 160-x sending a create/update derived cluster local resource message (step 411) to the API 103-x, which forwards the message (step 413) to the cluster's local database 105-x.

The federation controller 160-x then watches for creation/updating of the local resource by sending a “watch resource” message (step 415) to the API 103-x, which forwards the message (step 417) to the local database 105-x. It is noted that if a “watch resource” message had been sent to the local database 105-x earlier (e.g., as part of resource creation) and is still in effect, it is not necessary to send again (e.g., for resource updating).

After the local database 105-x has carried out the requested local resource creation/modification, it routes a corresponding notification (step 419) through the API 103-x to each “watching” entity, which means in this instance that the API 103-x forwards the notification to the standard Kubernetes controllers 107-x (step 421) and also to the cluster's federation controller 160-x (step 425).

It is further noted that once a local resource is created or modified in the local database 105-x, the standard Kubernetes controllers 107-x manage the resource instance (step 423) in a conventional way.

In response to receiving the notification from the local database 105-x, the cluster's federation controller 160-x updates the status of the corresponding federation resource stored in the distributed federation database 150 (step 427). This change in status will trigger further notifications to all entities (in particular all cluster federation controllers 160-x) that are “watching” the distributed federation database 150. This aspect is described in further detail later in this description.

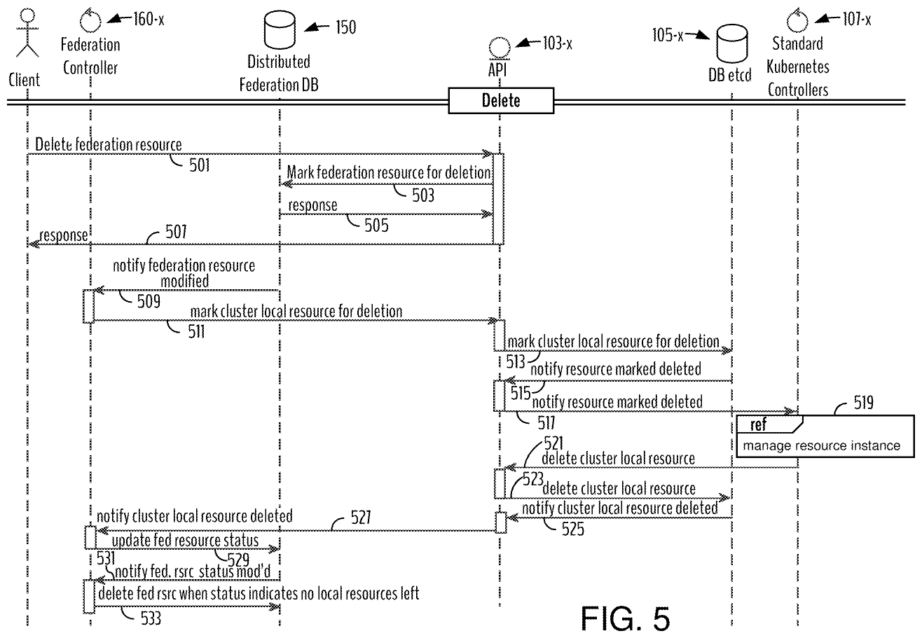

A similar signaling/control strategy is used when an existing federation resource is to be deleted. This will now be described in further detail with reference to FIG. 5. Creating a federation resource and updating a federation resource follow the same type of processing, which begins with a client sending a message (“delete federation resource”) (step 501) to an API 103-x of any one of the clusters within the federation 100. Again, it will be noted that it does not matter which of the clusters receives the message because once the distributed federation database 150 is modified, all of the clusters in the federation 100 will be notified about the modification, and thereby be able to respond if appropriate.

Upon receipt of the client's message, the API 103-x forwards a “mark federation resource for deletion” message to the distributed federation database 150 (step 503). In return, the distributed federation database 150 sends a response (step 505) to the API 103-x, which forwards the response back to the client (step 507).

The distributed federation database 150 also sends a notification concerning the database creation/modification to each federation controller 160-x that is “watching” the distributed federation database 150 (step 509), and in practice this should be every cluster in the federation 100.

Assuming that the create/update federation resource instruction is applicable to the cluster (depending on the particular contents of the notification, the federation controller 160-x may need to perform an analysis to decide the notification's applicability to the cluster), the cluster's federation controller 160-x causes the cluster's local database 105-x to be modified. This is achieved by the federation controller 160-x sending a “Mark cluster local resource for deletion” message (step 511) to the API 103-x, which forwards the message (step 513) to the cluster's local database 105-x.

The federation controller 160-x then watches for deletion of the local resource. (A previous “watch resource” message sent to the local database 105-x will still be in effect. If not, it should be re-issued so the federation controller 160-x can watch for deletion of the local resource.)

The local database 105-x carries out the requested deletion by sending a notification to all “watching” entities, indicating “resource marked deleted” (step 515). Of relevance to this discussion is that the notification is routed to the standard Kubernetes controllers 107-x (step 517), which manage the resource instance accordingly (step 519). In this instance, this means causing the cluster local resource to be deleted by sending a “delete cluster local resource” message to the API 103-x (step 521). The API 103-x forwards the message to the cluster's local database 105-x (step 523), which carries out the requested deletion, and sends a notification to all “watching” entities that the cluster local resource has been deleted (step 525). In this instance the API 103-x forwards the notification to the cluster's federation controller 160-x (step 527). (The notification is also sent to any other entity that is watching the cluster local resource, but these further notifications are not shown in the figure because they are not relevant to the discussion.)

In response to receiving the notification from the local database 105-x, the cluster's federation controller 160-x updates the status of the corresponding federation resource stored in the distributed federation database 150 (step 529). This change in status will trigger further notifications to all entities (in particular all cluster federation controllers 160-x) that are “watching” the distributed federation database 150.

Accordingly, the cluster's federation controller 160-x receives a notification of deletion of its own local resource. However, it will be appreciated that the actions described with respect to the one cluster depicted in FIG. 5 are also being carried out in parallel by other clusters in the federation 100, and these are also deleting their local resources. These other deletions similarly result in notifications of change of status, and these other notifications are received by the cluster's federation controller 160-x (step 531).

When the received status shows that no corresponding local resources exist in any of the clusters within the federation 100, the cluster's federation controller 160-x then instructs the distributed federation database 150 to delete the federation resource indicated in the client's original message. (Up until this point, the federation resource was only “marked for deletion”, because it could not actually be deleted until every local instance that had been created within the federation had in fact been deleted.)

The description has so far focused on deterministic resource handling. But in another aspect of the technology, local instances of federation resources can be created in a nondeterministic way, with control over the number of local resources to be created in any particular cluster being distributed among the clusters. In particular, the scheduling class of resource management is able to scale a defined aggregate amount of resources over a set of clusters. The client describes the amount of resources it desires and optionally also a policy for distribution (e.g., weighting clusters or setting minimum and maximum number of resources at a cluster, closeness to other resource, service, client, etc.).

In overview, this involves each distributed federation controller 160-x at each cluster performing these actions:
1. Watch for a specification declaring a desired amount of a resource
   a. In some but not necessarily all alternative embodiments, also read policy for resource distribution
2. Determine this cluster's (i.e., cluster x's) suitability for handling the request
   a. Derive a suitability parameter, for example as a probability between 0 and 1, based on the policy and cluster-specific information such as infrastructure (CPU, memory, disk, network bandwidth, etc.) available and functioning.
   b. Derive the number of resources that are presently needed based on suitability parameters and the number of resources already committed by other clusters' federation controllers. For example, by accumulating the amount of all resources committed so far by other clusters having a higher suitability, and determining how many more are still needed.
   c. Derive a suitable number of resources that can be handled at the cluster, without committing more than the needed amount of resources.
3. Commit to handling the amount of resources derived.
   a. Store the suitability parameter and the committed amount of resources to the distributed database, for all federation controllers to read.
4. Adjust the actual number of resources in the cluster based on the committed number of resources (i.e., either up or down).

Each federation controller 160-x that is performing the scheduling does not need to worry about conflicting accesses by other such controllers to the commonly accessible distributed federation database 150 because the strategy involves each federation controller 160-x adjusting only its own values in the distributed database. The complete knowledge of the federation resource is made by each federation controller 160-x aggregating the information. At any given moment, the perceived complete knowledge may differ between clusters, due to values in the distributed database having not yet propagated to a cluster. This may result in temporary over- and under-commitments. When notification of updated values propagates to a given cluster, it can evaluate these and adjust the number of its committed resources accordingly. In this way, the process is an iterative one, with final commitment values eventually settling out. If it is expected that the federation could end up with endless looping (i.e., in which a first cluster's adjustment causes a second cluster's adjustment, which causes the first cluster to revert to a previous commitment value, which causes the second cluster to revert to its previous commitment value, and so on), such embodiments can additionally include a strategy for avoiding such looping such as (and without limitation) by introducing a back-off time for federation controllers to wait before making further adjustments, in order to break any tight dependency loop.

The process can be improved by also adjusting the committed amount of resources by the suitability parameter, for example so that when a cluster's suitability is low, it takes smaller and more steps towards the desired amount of resources in order to allow more suitable clusters to commit a larger amount of resources in fewer and larger steps.

Separately, the availability of a cluster is monitored so that the amount of resources committed by such clusters may be discarded.

The following is an example of a federated resource that defines an aggregate number of resources that are to be instantiated at the local level within two clusters:

```
apiVersion: types.kubefed.io/vlbetal
kind: FederatedDeployment
metadata:
  name: test-deployment
  namespace: test-namespace
spec:
  template:
    metadata:
      labels:
        app: nginx
    spec:
      replicas: 3
      selector:
        matchLabels :
          app: nginx
      template:
        metadata:
          labels:
            app: nginx
        spec:
          containers:
          - image: nginx
            name: nginx
  placement:
    clusters:
    - name: cluster2
    - name: cluster1
  overrides:
  - clusterName: cluster2
    clusterOverrides:
    - path: “/spec/replicas”
      value: 5
    - path: “/spec/template/spec/containers/0/image”
      value: “nginx:1.17.0-alpine”
    - path: “/metadata/annotations”
      op: “add”
      value:
        foo: bar
    - path: “/metadata/annotations/foo”
      op: “remove”
```

And here are the derived local resources in each cluster, based on the above:

```
apiVersion: apps/v1
kind: Deployment
metadata:
  name: test-deployment
  namespace: test-namespace
  labels:
    app: nginx
spec:
  replicas: 3
  selector:
    matchLabels:
      app: nginx
  template:
    metadata:
      labels:
        app: nginx
    spec:
      containers:
      - image: nginx
        name: nginx
apiVersion: apps/v1
kind: Deployment
metadata:
  name: test-deployment
  namespace: test-namespace
  labels:
    app: nginx
spec:
  replicas: 5
  selector:
    matchLabels:
      app: nginx
  template:
    metadata:
      labels:
        app: nginx
    spec:
      containers:
      - image: nginx:1.17.0-alpine
        name: nginx
```

Note that the override for cluster 2 declares that the label foo is first created but then removed. This results in its not being present, but the change of image is made. If there were a third cluster (cluster 3), it would not get the derived Deployment resource.

The above examples show the resources in a YAML text format, with “:” making the left part an attribute, indentation making a sub-attribute and “-” meaning a list item. (To read lists correctly, it should be kept in mind that all indicated items are attributes until next the next “-” at that indentation level.) The attribute “kind” declares what kind of federation resource is being declared. In this case it is a FederationDeployment, which will be derived by the federation controller to a Deployment kind as a local resource. The attribute “spec” contains a “template” attribute defining the template to be used for the Deployment resource by the federation controller. The “spec” attribute also contains a “placement” attribute that defines the policy for placement of the derived resource, in this example directly specifying the cluster names that should receive the derived Deployment resource. The “spec” attribute also contains an “overrides” attribute that, for each cluster, defines modification from the template to the derived resource. Each “clusterOverrides” item follows a sub-set of the JSON-patch standard RFC 6902 from the IETF, see also information that can be found on the Internet at jsonpatch.com. Regarding terminology, JSON refers to JavaScript Object Notation, and YAML is known in the industry as “YAML Ain′t Markup Language”. Both JSON and YAML are very common languages for text formatting of structured data. Same data structures can be formatted in both ways, which is why a JSON-patch is applicable to something formatted as YAML, since actually working on the data structures.

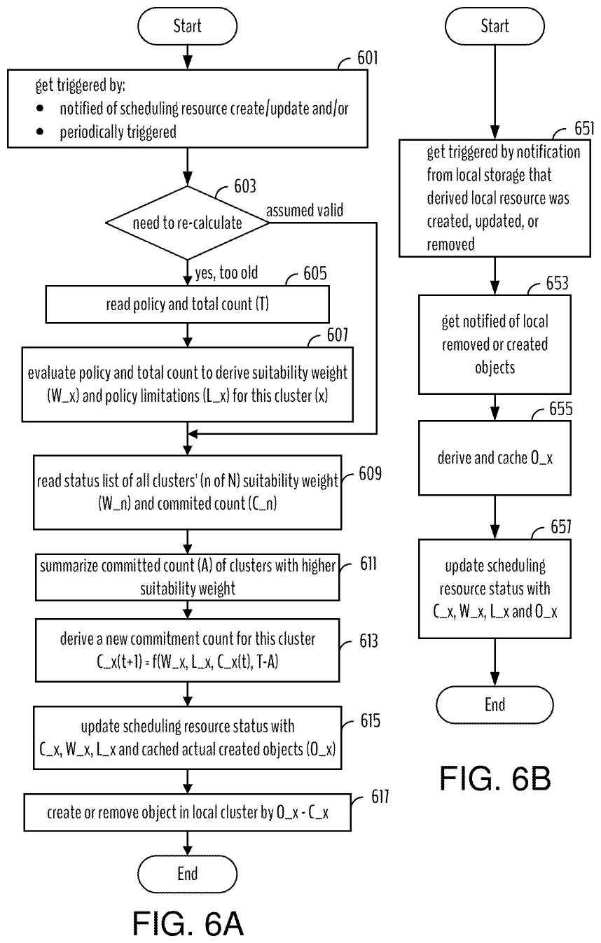

Further aspects related to dynamic, distributed scheduling of resources among a federation of clusters will now be described with respect to FIGS. 6A and 6B, which are flowcharts of actions performed by each federation controller 160-x (i.e., each one of the controllers performs the illustrated actions, with values being locally determined).

Referring first to FIG. 6A, as shown in step 601, performance of the scheduling actions can be triggered (i.e., initiated) by receiving a notification that a scheduling resource is to be created or updated. In alternative embodiments scheduling actions can be triggered periodically. And in still other alternatives, both forms of triggering can be used together in a single embodiment.

Once triggered, the federation controller 160-x decides whether the triggering concerns a previously scheduled resource (decision block 603). If this is a new resource (“No” path out of decision block 603), it is decided whether certain parameters that will guide the scheduling are new enough to be assumed valid, or whether they need to be re-calculated (decision block 603). If there is a need for recalculation (“yes, too old” path out of decision block 603), then the federation controller 160-x reads the policy and the total count (T) (step 605). The policy and total count are then evaluated to derive a suitability weight (W_x) and also policy limitations (L_x) for this particular cluster (x) (step 607).

The federation controller 160-x then reads the status list of all clusters' (n out of a total N clusters) suitability weight (W_i) and committed count (C_i) (step 609).

After all of the other clusters' information has been gathered, the federation controller 160-x summarizes the committed count (A) of those clusters having a higher suitability weight (step 611). This allows the federation controller 160-x to determine how many resources still need to be committed within the federation, and consequently, in step 613, derives a new commitment count for this cluster (x) in accordance with:

C_x(t+1)=f(W_x,L_x,C_x(t),T-A).

After deriving the new commitment count, the federation controller 160-x, the federation controller 160-x updates the scheduling resource status in the distributed federation database 150 with the new values for C_x, W_x, L_x and cached (i.e., previously locally stored) actually created objects (O_x) (step 615). Also, as shown in step 617, the federation controller 160-x creates or removes one or more objects in the local cluster, the number being determined in accordance with:

Number of created or removed objects=O_x−C_x.

Referring to FIG. 6B, the scheduling can also be triggered by a notification (step 651) from local storage 105-x that a derived local resource has been created, updated, or removed. Accordingly, the federation controller 160-x assesses the notification (step 653), derives and caches a new O_x (step 655), and then updates the scheduling resource status (in the distributed federation database 150) with updated values for C_x, W_x, L_x, and O_x (step 657).

This aspect relating to notification from the local storage 105-x is important because it allows the federation controller 160-x to know that the requested local transaction has actually been handled. With this knowledge, the federation controller 160-x can than update the status of the federation resource. Also, as shown in FIG. 6B, the federation controller 160-x uses the notifications from the local storage 105-x to maintain its cached value of the number of instantiated local resources, and this is the value that is used when making the federation resource status update.

In another aspect, when the derived resource contains a replication number and a status attribute of how many sub-resources are functional (which is how, for example, a Deployment works with sub-resource pods), then the notification of updates to the derived resource status (e.g. Deployment) would contain how many sub-resources (e.g., Pods) are functional. This number is then used to calculate the O_x. This is another reason to keep track not only of what local storage modifications have been ordered, but also what have been achieved. This means that, in this example involving sub-resources, status changes involve changing the replication number in the derived resource.

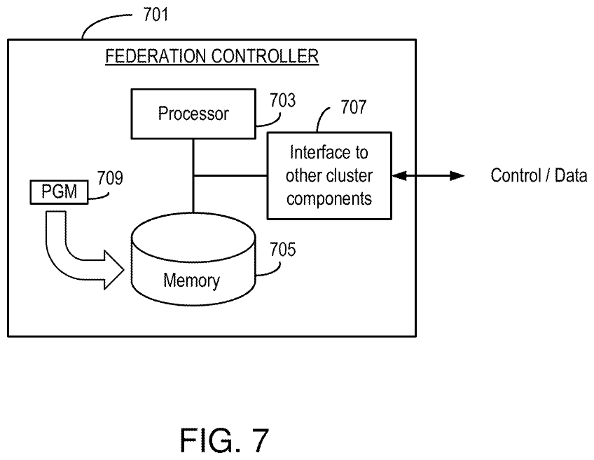

Other aspects of a federation controller 160-x are shown in FIG. 7, which illustrates an exemplary federation controller 701 in accordance with some but not necessarily all exemplary embodiments consistent with the invention. In particular, the federation controller 701 includes circuitry configured to carry out any one or any combination of the various functions described above (see, e.g., FIGS. 2 through 6). Such circuitry could, for example, be entirely hard-wired circuitry (e.g., one or more Application Specific Integrated Circuits— “ASICs”). Depicted in the exemplary embodiment of FIG. 7, however, is programmable circuitry, comprising a processor 703 coupled to one or more memory devices (non-transitory computer readable media) 705 (e.g., Random Access Memory, Magnetic Disc Drives, Optical Disk Drives, Read Only Memory, etc.) and to an interface 707 that enables bidirectional communication with other elements of the cluster (see, e.g., the API 103-x, and the distributed federation database 150). The memory device(s) 705 store program means 709 (e.g., a computer program product comprising at least a set of processor instructions, and in some embodiments stored on a non-transitory computer readable storage medium such as a CD) configured to cause the processor 703 to control other cluster elements so as to carry out any of the aspects described above, such as but not limited to those described with reference to FIGS. 2 through 6. The memory device(s) 705 may also store data (not shown) representing various constant and variable parameters as may be needed by the processor 703 and/or as may be generated when carrying out its functions such as those specified by the program means 709.

The various aspects of the herein-described technology provides advantages over conventional arrangements including, but not limited to, greatly improved scalability and availability, and maintained dynamic fast multi-cluster control.

The invention has been described with reference to particular embodiments. However, it will be readily apparent to those skilled in the art that it is possible to embody the invention in specific forms other than those of the embodiment described above. Thus, the described embodiments are merely illustrative and should not be considered restrictive in any way. The scope of the invention is further illustrated by the appended claims, rather than only by the preceding description, and all variations and equivalents which fall within the range of the claims are intended to be embraced therein.

1. An arrangement comprising:
a plurality of clusters; and
an interface through which a distributed federation database is accessible,
wherein each of the clusters comprises:
a cluster interface;
a cluster local memory configured to store local cluster resources; and
a federation controller, wherein the federation controller is configured to:
receive a first notification from the distributed federation database wherein the first notification indicates a change relating to a federation resource in the distributed federation database;
analyze the first notification;
modify a local resource based on the analysis; and
update a status of the federation resource in the distributed federation database when the local resource has been stored.

2. The arrangement of claim 1, wherein the federation controller being configured to receive the first notification from the distributed federation database comprises the federation controller being configured to initiate receipt of notifications from the distributed federation database by sending a watch federation resources message to the distributed federation database.

3. The arrangement of claim 1, wherein the federation controller is configured to:
detect when the first notification from the distributed federation database indicates that the federation resource has been created, and in response thereto, to:
derive a cluster local resource when the analysis indicates that the cluster local resource should be derived;
store the derived cluster local resource in the cluster local memory; and
update the status of the federation resource in the distributed federation database when the derived cluster local resource has been stored.

4. The arrangement of claim 1, wherein the federation controller is configured to:
detect when the first notification from the distributed federation database indicates that the federation resource has been updated, and in response thereto, to:
derive an updated cluster local resource when the analysis indicates that a previously stored cluster local resource should be updated;
store the derived updated cluster local resource in the cluster local memory; and
update the status of the federation resource in the distributed federation database when the derived updated cluster local resource has been stored.

5. The arrangement of claim 1, wherein the federation controller is configured to:
detect when the first notification from the distributed federation database indicates that the federation resource has been marked for deletion, and in response thereto, to:
determine that a corresponding derived cluster local resource should be deleted;
delete the corresponding derived cluster local resource from the cluster local memory;
update the status of the federation resource in the distributed federation database when the corresponding derived cluster local resource has been deleted from the cluster local memory; and
receive a second notification from the distributed federation database indicating that no derived cluster local resources corresponding to the federation resource are stored in any of the plurality of clusters, and in response to the second notification to delete the federation resource from the distributed federation database.

6. The arrangement of claim 1, wherein the federation controller is comprised within a first one of the plurality of clusters and is configured to:
detect when the first notification indicates a scheduling federation resource including a request for creation of an aggregate number of instances of a resource among the plurality of clusters;
respond to the specification by:
deriving a suitability parameter that represents how suitable the first one of the plurality of clusters is for handling the request;
deriving a number of resources to be handled by the first cluster, wherein the number is based at least in part on the suitability parameter; and
updating the status of the federation resource in the distributed federation database to indicate the suitability parameter and the number of resources to be handled by the first cluster.

7. The arrangement of claim 6, wherein the federation controller is further configured to:
receive one or more further notifications, each indicating an updated status of the scheduling federation resource, and in response thereto to retrieve a suitability parameter of at least one other one of the plurality of clusters and a committed number of resources to be handled by said at least one other one of the plurality of clusters;
derive an adjusted number of resources to be handled by the first cluster based at least in part on the suitability parameter of the first cluster and the suitability parameters of said at least one other one of the plurality of clusters, and the committed number of resources to be handled by said at least one other one of the plurality of clusters; and
update the status of the federation resource in the distributed federation database to indicate the suitability parameter of the first cluster and the adjusted number of resources to be handled by the first cluster.

8. The arrangement of claim 6, wherein the federation controller is further configured to:
create a number of derived local cluster resources in correspondence with the number of resources to be handled by the first cluster or in correspondence with the adjusted number of resources to be handled by the first cluster;
store the derived local cluster resources in the cluster local memory; and
update the status of the federation resource in the distributed federation database when the derived local cluster resources have been stored in the cluster local memory.

9. The arrangement of claim 6, wherein:
the scheduling resource includes a policy that governs creation of the resources to be created among the plurality of clusters; and
the federation controller is configured to derive the suitability parameter based at least in part on the policy.

10. The arrangement of claim 6, wherein the federation controller is configured to derive the suitability parameter based on cluster-specific information.

11. The arrangement of claim 6, wherein deriving the number of resources to be handled by the first cluster comprises selecting a higher number of resources to be handled by the first cluster the higher the suitability parameter is.

12. The arrangement of claim 1, further comprising:
the distributed federation database.

13. A method of operating an arrangement that comprises a plurality of clusters and an interface through which a distributed federation database is accessible, wherein each of the clusters comprises:
a cluster interface;
a cluster local memory configured to store local cluster resources; and
a federation controller,
wherein the method is performed by each of the clusters, and comprises:
receiving a first notification from the distributed federation database, wherein the first notification indicates a change relating to a federation resource in the distributed federation database;
analyzing the first notification;
modifying a local resource based on the analysis; and
updating a status of the federation resource in the distributed federation database when the local resource has been stored.

14. The method of claim 13, wherein receiving the first notification from the distributed federation database comprises initiating receipt of notifications from the distributed federation database by sending a watch federation resources message to the distributed federation database.

15. The method of claim 13, comprising:
detecting when the first notification from the distributed federation database indicates that the federation resource has been created, and in response thereto:
deriving a cluster local resource when the analysis indicates that the cluster local resource should be derived;
storing the derived cluster local resource in the cluster local memory; and
updating the status of the federation resource in the distributed federation database when the derived cluster local resource has been stored.

16. The method of claim 13, comprising:
detecting when the first notification from the distributed federation database indicates that the federation resource has been updated, and in response thereto:
deriving an updated cluster local resource when the analysis indicates that a previously stored cluster local resource should be updated;
storing the derived updated cluster local resource in the cluster local memory; and
updating the status of the federation resource in the distributed federation database when the derived updated cluster local resource has been stored.

17. The method of claim 13, comprising:
detecting when the first notification from the distributed federation database indicates that the federation resource has been marked for deletion, and in response thereto, to:
determining that a corresponding derived cluster local resource should be deleted;
deleting the corresponding derived cluster local resource from the cluster local memory;
updating the status of the federation resource in the distributed federation database when the corresponding derived cluster local resource has been deleted from the cluster local memory; and
receiving a second notification from the distributed federation database indicating that no derived cluster local resources corresponding to the federation resource are stored in any of the plurality of clusters, and in response to the second notification to delete the federation resource from the distributed federation database.

18. The method of claim 13, wherein the method comprises a first one of the plurality of clusters performing:
detecting when the first notification indicates a scheduling federation resource including a request for creation of an aggregate number of instances of a resource among the plurality of clusters;
responding to the specification by:
deriving a suitability parameter that represents how suitable the first one of the plurality of clusters is for handling the request;
deriving a number of resources to be handled by the first cluster, wherein the number is based at least in part on the suitability parameter; and
updating the status of the federation resource in the distributed federation database to indicate the suitability parameter and the number of resources to be handled by the first cluster.

19. The method of claim 18, further comprising the first one of the plurality of clusters performing:
receiving one or more further notifications, each indicating an updated status of the scheduling federation resource, and in response thereto to retrieve a suitability parameter of at least one other one of the plurality of clusters and a committed number of resources to be handled by said at least one other one of the plurality of clusters;
deriving an adjusted number of resources to be handled by the first cluster based at least in part on the suitability parameter of the first cluster and the suitability parameters of said at least one other one of the plurality of clusters, and the committed number of resources to be handled by said at least one other one of the plurality of clusters; and
updating the status of the federation resource in the distributed federation database to indicate the suitability parameter of the first cluster and the adjusted number of resources to be handled by the first cluster.

20. The method of claim 18, wherein the first one of the plurality of clusters further performs:
creating a number of derived local cluster resources in correspondence with the number of resources to be handled by the first cluster or in correspondence with the adjusted number of resources to be handled by the first cluster;
storing the derived local cluster resources in the cluster local memory; and
updating the status of the federation resource in the distributed federation database when the derived local cluster resources have been stored in the cluster local memory.

21. The method of claim 18, wherein:
the scheduling resource includes a policy that governs creation of the resources to be created among the plurality of clusters; and
the first one of the clusters further performs deriving the suitability parameter based at least in part on the policy.

22. The method of claim 18, wherein the first one of the clusters performs deriving the suitability parameter based on cluster-specific information.

23. The method of claim 18, wherein deriving the number of resources to be handled by the first cluster comprises selecting a higher number of resources to be handled by the first cluster the higher the suitability parameter is.

24. A computer program product stored on a non-transitory tangible computer readable medium comprising instructions that cause a processor to:
receive a first notification from a distributed federation database, wherein the first notification indicates a change relating to a federation resource in the distributed federation database;
analyze the first notification;
modify a local resource based on the analysis; and
update a status of the federation resource in the distributed federation database when the local resource has been stored.

25. (canceled)
